(19) United States
(12) Patent Application Publication
(10) Pub. No.: US 2021/0023507 A1
(43) Pub. Date: Jan. 28, 2021

(54) GRAPHENE FILTER MODULE FOR WATER TREATMENT

(71) Applicant: STANDARDGRAPHENE CO., LTD., Ulsan (KR)

(72) Inventors: Joung-Hoon LEE, Ulsan (KR); Sangho Kim, Ulsan (KR); Myeong-Sin Lee, Ulsan (KR); Seungyun Han, Ulsan (KR)

(21) Appl. No.: 16/925,353

(22) Filed: Jul. 10, 2020

Related U.S. Application Data
(63) Continuation of application No. PCT/KR2019/000532, filed on Jan. 14, 2019.

(30) Foreign Application Priority Data
Jan. 12, 2018 (KR) 10-2018-0004211

(51) Int. Cl. B01D 71/02; B01D 63/14; B01D 69/02; C02F 1/44; B01D 69/14

(52) U.S. Cl. CPC B01D 71/021; B01D 63/14; B01D 69/02; B01D 2325/12; B01D 69/147; B01D 2325/02; C02F 1/44

(57) ABSTRACT

The present disclosure relates to a graphene filter module for water treatment including a graphene filter layer.

### CROSS-REFERENCE TO RELATED APPLICATIONS

This application is a continuation of PCT Application No. PCT/KR2019/000532 filed on Jan. 14, 2019, which claims priority to Korean Patent Application No. 10-2018-0004211 filed on Jan. 12, 2018, the entire disclosures of which are hereby incorporated herein by reference.

### TECHNICAL FIELD

The present disclosure relates to a graphene filter module for water treatment including a graphene filter layer.

### BACKGROUND

Most of raw water we use is obtained from streams and rivers, and is filtered through various steps such as sedimentation, chemical treatment, and disinfection to filter out various foreign substances and impurities, thereby providing clean water to homes and industrial sites. Due to the recent development of the industry, natural waters such as lakes, streams, and rivers, are becoming more and more polluted due to industrial waste and domestic wastewater.

As the pollution of water becomes serious, it cannot be used without water treatment, and recently, it is common to add a water purifier at home to purify and drink tap water once more.

This method requires a high installation cost and a large site while undergoing coagulation, sedimentation, chemical treatment steps, and the like in a water purification plant, and accordingly, the installation cost is limited.

The contaminated raw water is passed through the water purification plant and additionally through an ordinary household water purifier before it is returned to drinkable water.

Despite using an additional water purifier to drink clean water, not only the water is not purified well, but also trust in the water purifier, such as heavy metals, is decreased.

Accordingly, there is an urgent need to develop a water filter which is capable of filtering ultra-fine particles, heavy metals, and the like, and in which water purification steps are reduced.

### SUMMARY OF INVENTION

### Technical Problem

The present disclosure relates to a graphene filter module for water treatment including a graphene filter layer.

However, problems to be solved by the present application are not limited to the problems described above, and other problems not mentioned will be clearly understood by those skilled in the art from the following description.

### Solution to Problem

In accordance with a first aspect of the present disclosure, there is provided a graphene filter module including: an outer membrane layer forming an outer surface of the graphene filter module; an inner membrane layer disposed inside the outer membrane layer; and a graphene filter layer disposed between the outer membrane layer and the inner membrane layer, wherein inflow water is filtered through the outer membrane layer, the graphene filter layer, and the inner membrane layer.

### Advantageous Effects

According to embodiments of the present disclosure, the inflow raw water is filtered three times through the outer membrane layer, the graphene filter layer, and the inner membrane layer, and thereby contaminants in the raw water can be effectively removed.

In the graphene filter module according to an embodiment of the present disclosure, since the outer membrane layer, the graphene filter layer, and the inner membrane layer are integrated into a single module, it can be used for from a household water purifier, a washing filter, a bidet filter, and a shower filter, to large-capacity wastewater treatment.

According to the embodiments of the present disclosure, contaminants can be effectively removed through the three filter layers, and in particular, clear purified water can be obtained by removing dyed fine particles in dyed wastewater by the graphene filter layer.

### BRIEF DESCRIPTION OF THE DRAWINGS

FIG. 1 is a schematic view showing a structure of a graphene filter module in one embodiment of the present disclosure.

FIG. 2 is a sectional view of an outer membrane layer, a graphene filter layer, and an inner membrane layer of the graphene filter module, in accordance with an embodiment of the present disclosure.

FIG. 3 is a schematic view showing a structure of an A-type graphene filter module, in accordance with an embodiment of the present disclosure.

FIG. 4 is a schematic view showing a structure of a B-type graphene filter module, in accordance with an embodiment of the present disclosure.

FIG. 5 is a schematic view showing a structure of the B-type graphene filter module, in accordance with an example of the present disclosure.

FIG. 6A and FIG. 6B are comparative images showing before and after a water treatment experiment of the graphene filter module, in accordance with an example of the present disclosure.

FIG. 7A, FIG. 7B, and FIG. 7C are images showing results of water treatment experiments of the A-type graphene filter module, in accordance with an example of the present disclosure.

FIG. 8 shows a filter system using the B-type graphene filter module, in accordance with an example of the present disclosure.

FIG. 9 is a comparative image showing before and after a water treatment experiment of a filter system using the B-type graphene filter module, in accordance with an example of the present disclosure.

FIG. 10 shows an example of a reverse osmosis (RO) water purifier using a graphene filter module, in accordance with an embodiment of the present disclosure.

FIG. 11 shows an example of a reverse osmosis (RO) water purifier using a graphene filter module, in accordance with an embodiment of the present disclosure.

### BEST MODE

Hereafter, embodiments and examples of the present disclosure will be described in detail with reference to the accompanying drawings so that the present disclosure may be readily implemented by a person with ordinary skill in the art. However, it is to be noted that the present disclosure is not limited to the embodiments and examples but can be embodied in various other ways. In the drawings, parts irrelevant to the description are omitted for the simplicity of explanation, and like reference numerals denote like parts through the whole document.

Throughout the whole document, the term “connected to” may be used to designate a connection or coupling of one element to another element and includes both an element being “directly connected to” another element and an element being “electronically connected to” another element via another element.

Through the whole document, the term “on” that is used to designate a position of one element with respect to another element includes both a case that the one element is adjacent to the other element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the whole document, the term “combination(s) of” included in Markush type description means one or more mixture or combination from the group consisting of components described in Markush type and thereby means that the disclosure includes one or more components selected from the Markush group.

Through the whole document, a phrase in the form “A and/or B” means “A or B, or A and B”.

Throughout the whole document, the term “graphene” is a term in which a plurality of carbon atoms are connected to each other by a covalent bond to form a six-membered ring as a basic repeating unit, but a five-membered ring and/or a seven-membered ring can be further included. Therefore, a sheet formed by the graphene can be seen as a single layer of carbon atoms covalently bonded to each other, but may not be limited thereto. The sheet formed by the graphene can have various structures, and such structures can vary depending on a content of the five-membered ring and/or the seven-membered ring that can be included in the graphene. In addition, in a case where the sheet formed by the graphene is configured of a single layer, the sheets can be stacked with each other to form a plurality of layers, and side end portions of the graphene sheet can be saturated with hydrogen atoms, but may not be limited thereto.

Throughout the whole document, the term “graphene oxide” is also called graphene oxide and can be abbreviated as “GO”. The single-layer graphene can include a structure thereon, in which a functional group containing oxygen, such as a carboxyl group, a hydroxy group, or an epoxy group, is bonded, but may not be limited thereto.

Throughout the whole document, the term “reduced graphene oxide” means graphene oxide having a reduced oxygen ratio through a reduction process and can be abbreviated as “rGO”, but may not be limited thereto.

Throughout the whole document, the term “graphene nano platelet” refers to a material having 10 to 100 layers of carbon layers of natural graphite manufactured by a physical or chemical method and can be abbreviated as “GNP”, but may not be limited thereto.

Hereinafter, embodiments and examples of the present disclosure will be described in detail with reference to the accompanying drawings. However, the present disclosure cannot be limited to the following embodiments, examples, and drawings.

In accordance with a first aspect of the present disclosure, there is provided a graphene filter module including: an outer membrane layer forming an outer surface of the graphene filter module; an inner membrane layer disposed inside the outer membrane layer; and a graphene filter layer disposed between the outer membrane layer and the inner membrane layer, wherein inflow water is filtered through the outer membrane layer, the graphene filter layer, and the inner membrane layer.

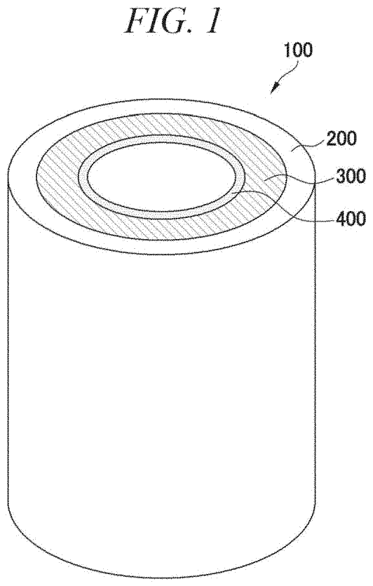

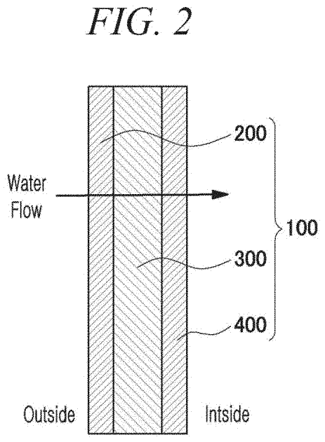

A graphene filter module 100 according to an embodiment of the present disclosure can be described with reference to FIGS. 1 and 2. For example, the graphene filter module 100 may include three layers. For example, it may consist of an outer membrane layer 200 forming an outer surface of the graphene filter module, a graphene filter layer 300 including graphene, and an inner membrane layer 400, in which the graphene filter layer may be disposed between the outer membrane layer and the inner membrane layer.

In an embodiment of the present disclosure, while raw water, which is contaminated water, passes through the three filters, micro-sized and nano-sized fine particles or ultra-fine particles may be filtered to be removed, but may not be limited thereto. For example, in the contaminated water, large particle impurities, medium-sized impurities, heavy metals, and/or bacteria are removed by the outer membrane layer, ultra-fine particles of approximately 10 nm to approximately 100 nm, which are not removed by the outer membrane layer, are removed by oxygen-containing functional groups, pinholes, nanopores, or the like, and finally, impurities that are not removed can be removed while passing through the inner membrane layer, but may not be limited thereto.

In an embodiment of the present disclosure, the graphene filter module may be formed in an A-type structure consisting of the outer membrane layer, the graphene filter layer, and the inner membrane layer; or a B-type structure including a graphene filter layer which is filled with the graphene in a powder form, but may not be limited thereto.

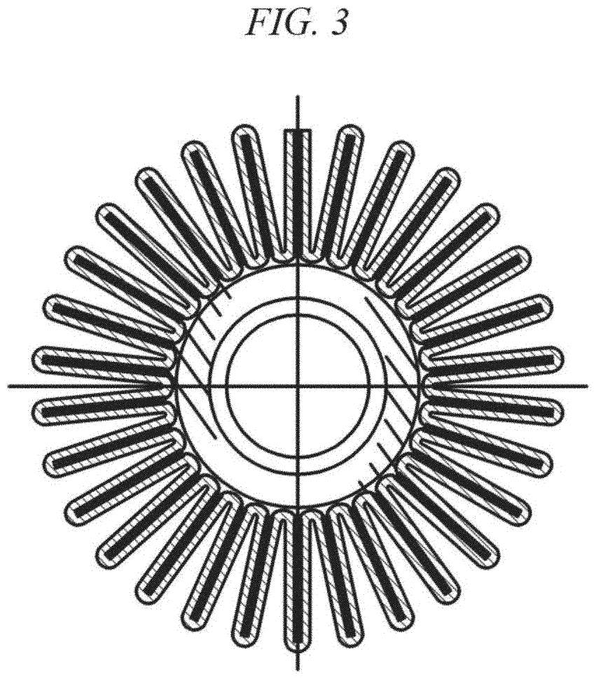

In an embodiment of the present disclosure, referring to FIG. 3, the A-type graphene filter module may have a structure formed in a corrugated structure in which a surface area is increased by folding, like a fan, graphene-containing filter paper consisting of the outer membrane layer, the graphene filter layer, and the inner membrane layer, but may not be limited thereto.

In an embodiment of the present disclosure, in a case where the graphene filter module is formed in the A-type structure of the corrugated membrane consisting of the outer membrane layer, the graphene filter layer, and the inner membrane layer, it may be used for household use, but may not be limited thereto. For example, it may be used as a household water purifier or shower, but may not be limited thereto.

In an embodiment of the present disclosure, in a case where the graphene filter module is formed in the A-type structure of the corrugated membrane consisting of the outer membrane layer, the graphene filter layer, and the inner membrane layer, the outer membrane layer or the inner membrane layer may use at least one selected from cellulose, glass fiber, polyethylene (PE), polypropylene (PP) fiber, carbon fiber, activated carbon fiber, and polyethylene terephthalate (PET), but may not be limited thereto.

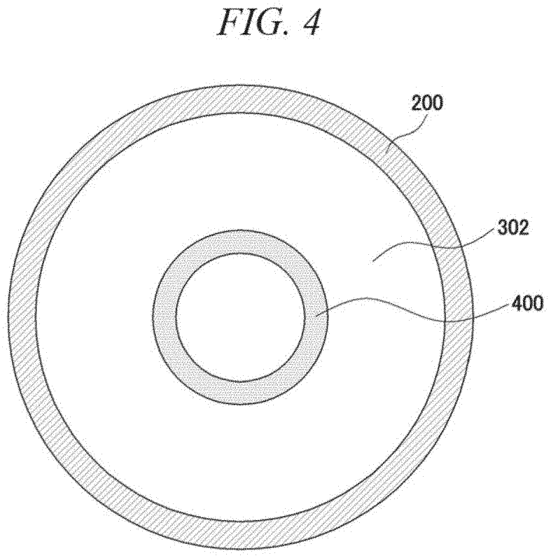

Alternatively, for example, referring to FIG. 4, the graphene filter module may have the B-type structure in which a portion between the outer membrane layer 200 forming an outer surface of the graphene filter module and the inner membrane layer 400 disposed inside the outer membrane layer is filled with the graphene in the powder form (FIG. 4).

In an embodiment of the present disclosure, in a case where the graphene filter layer is formed in the B-type structure, which is filled with the graphene in the powder form, it may be used for industrial purposes, but may not be limited thereto. For example, it may be used for an industrial wastewater treatment filter, but may not be limited thereto.

In an embodiment of the present disclosure, in a case where the graphene filter layer is formed in the B-type structure, which is filled with the graphene in the powder form, the outer membrane layer or the inner membrane layer can use at least one selected from polypropylene (PP), polyethylene (PE), polyethylene terephthalate (PET), and ceramics as a membrane component, but may not be limited thereto.

In an embodiment of the present disclosure, in a case where the graphene filter layer is formed in the structure which is filled with the graphene in the powder form, an amount of the graphene is greater than that of a structure formed in a corrugated membrane containing the graphene, but may not be limited thereto.

In an embodiment of the present disclosure, the outer membrane layer and the inner membrane layer may be rigid, but may not be limited thereto. For example, it may include at least one material selected from cellulose, glass, alumina, activated carbon, polypropylene, and carbon black, but may not be limited thereto.

In an embodiment of the present disclosure, the outer membrane layer and the inner membrane layer may be respectively formed of different materials from each other, but may not be limited thereto.

In an embodiment of the present disclosure, the graphene filter layer can include at least one selected from a group consisting of graphene, graphene oxide, reduced graphene oxide, and graphene nano platelet (GNP), but may not be limited thereto.

In an embodiment of the present disclosure, the graphene filter layer may further include at least one selected from activated carbon, carbon black, zeolite, silica, ion exchange resin, alumina, kinetic degradation fluxion (KDF) filter, ceramic ball, and carbon nanotube, but may not be limited thereto.

In an embodiment of the present disclosure, a pore size of the graphene filter layer may be approximately 1 nm to approximately 20 nm, but may not be limited thereto. For example, the pore size of the graphene filter layer may be approximately 1 nm to approximately 20 nm, approximately 1 nm to approximately 15 nm, approximately 1 nm to approximately 10 nm, approximately 1 nm to approximately 5 nm, approximately 5 nm to approximately 20 nm, approximately 5 nm to approximately 15 nm, approximately 5 nm to approximately 10 nm, approximately 10 nm to approximately 20 nm, approximately 10 nm to approximately 15 nm, or approximately 15 nm to approximately 20 nm, but may not be limited thereto.

In an embodiment of the present disclosure, the graphene filter module may have different pore sizes in an inflow direction and an outflow direction, but may not be limited thereto.

In an embodiment of the present disclosure, in the case of the A-type graphene filter module, the pore size in the inflow direction may be approximately 0.1 μm to approximately 100 μm, approximately 0.1 μm to approximately 80 μm, approximately 0.1 μm to approximately 60 μm, approximately 0.1 μm to approximately 40 μm, approximately 0.1 μm to approximately 20 μm, approximately 0.1 μm to approximately 10 μm, approximately 0.1 μm to approximately 1 μm, approximately 1 μm to approximately 100 μm, approximately 1 μm to approximately 80 μm, approximately 1 μm to approximately 60 μm, approximately 1 μm to approximately 40 μm, approximately 1 μm to approximately 20 μm, approximately 1 μm to approximately 10 μm, approximately 10 μm to approximately 100 μm, approximately 10 μm to approximately 80 μm, approximately 10 μm to approximately 60 μm, approximately 10 μm to approximately 40 μm, approximately 10 μm to approximately 20 μm, approximately 20 μm to approximately 100 μm, approximately 20 μm to approximately 50 μm, or approximately 50 μm to approximately 100 μm, but may not be limited thereto.

In an embodiment of the present disclosure, in the case of the A-type graphene filter module, the pore size in the outflow direction may be approximately 0.1 μm to approximately 10 μm, approximately 0.1 μm to approximately 8 μm, approximately 0.1 μm to approximately 6 μm, approximately 0.1 μm to approximately 4 μm, approximately 0.1 μm to approximately 2 μm, approximately 0.1 μm to approximately 1 μm, approximately 1 μm to approximately 10 μm, approximately 1 μm to approximately 8 μm, approximately 1 μm to approximately 6 μm, approximately 1 μm to approximately 4 μm, approximately 1 μm to approximately 2 μm, approximately 2 μm to approximately 10 μm, approximately 2 μm to approximately 8 μm, approximately 2 μm to approximately 6 μm, approximately 2 μm to approximately 4 μm, approximately 4 μm to approximately 10 μm, approximately 4 μm to approximately 8 μm, approximately 4 μm to approximately 6 μm, approximately 6 μm to approximately 10 μm, approximately 6 μm to approximately 8 μm, or approximately 8 μm to approximately 10 μm, but may not be limited thereto.

In an embodiment of the present disclosure, in the case of the B-type graphene filter module, the pore size of the outer membrane layer may be approximately 0.1 μm to approximately 100 μm, but may not be limited thereto. For example, the pore size of the outer membrane layer may be approximately 0.1 μm to approximately 100 μm, approximately 0.1 μm to approximately 80 μm, approximately 0.1 μm to approximately 60 μm, approximately 0.1 μm to approximately 40 μm, approximately 0.1 μm to approximately 20 μm, approximately 0.1 μm to approximately 10 μm, approximately 0.1 μm to approximately 1 μm, approximately 1 μm to approximately 100 μm, approximately 1 μm to approximately 80 μm, approximately 1 μm to approximately 60 μm, approximately 1 μm to approximately 40 μm, approximately 1 μm to approximately 20 μm, approximately 1 μm to approximately 10 μm, approximately 10 μm to approximately 100 μm, approximately 10 μm to approximately 80 μm, approximately 10 μm to approximately 60 μm, approximately 10 μm to approximately 40 μm, approximately 10 μm to approximately 20 μm, approximately 20 μm to approximately 100 μm, approximately 20 μm to approximately 50 μm, or approximately 50 μm to approximately 100 μm, but may not be limited thereto.

In an embodiment of the present disclosure, in the case of the B-type graphene filter module, the pore size of the inner membrane layer may be approximately 0.1 μm to approximately 10 μm, but may not be limited thereto. For example, the pore size of the inner membrane layer may be approximately 0.1 μm to approximately 10 μm, approximately 0.1 μm to approximately 8 μm, approximately 0.1 μm to approximately 6 μm, approximately 0.1 μm to approximately 4 μm, approximately 0.1 μm to approximately 2 μm, approximately 0.1 μm to approximately 1 μm, approximately 1 μm to approximately 10 μm, approximately 1 μm to approximately 8 μm, approximately 1 μm to approximately 6 μm, approximately 1 μm to approximately 4 μm, approximately 1 μm to approximately 2 μm, approximately 2 μm to approximately 10 μm, approximately 2 μm to approximately 8 μm, approximately 2 μm to approximately 6 μm, approximately 2 μm to approximately 4 μm, approximately 4 μm to approximately 10 μm, approximately 4 μm to approximately 8 μm, approximately 4 μm to approximately 6 μm, approximately 6 μm to approximately 10 μm, approximately 6 μm to approximately 8 μm, or approximately 8 μm to approximately 10 μm, but may not be limited thereto.

In an embodiment of the present disclosure, fine particles having a diameter of less than approximately 10 μm included in the inflow water may be removed by the graphene filter layer, but may not be limited thereto. For example, due to a high specific surface area and porosity of the graphene in the graphene filter layer, contaminants contained in water can be adsorbed, organic substances can be adsorbed by an oxygen-containing functional group included in the graphene, or impurities can be removed by interposing between pinholes included in the graphene, but may not be limited thereto.

In an embodiment of the present disclosure, the oxygen-containing functional group may include at least one selected from hydroxyl group, an epoxy group, a carboxyl group, and a ketone group, but may not be limited thereto.

In an embodiment of the present disclosure, the graphene filter layer may remove ink, dye, or the like which is not removed by the drinking water filter of the related art. The ink or dye includes particles in a range of approximately 10 nm to approximately 100 nm, and particles included in the ink or dye may be adsorbed and removed by the oxygen-containing functional group, the pinholes, and the nano-sized pores included in the graphene filter layer, but may not be limited thereto.

In an embodiment of the present disclosure, fine particles having a diameter of less than approximately 10 μm included in the inflow water may be removed by the graphene filter layer, but may not be limited thereto. For example, due to the high specific surface area and porosity of the graphene in the graphene filter layer, contaminants contained in water can be adsorbed, organic substances can be adsorbed by the oxygen-containing functional group included in the graphene, or impurities can be removed by interposing between the pinholes included in the graphene, but may not be limited thereto.

In an embodiment of the present disclosure, the oxygen-containing functional group can include at least one selected from hydroxyl group, an epoxy group, a carboxyl group, and a ketone group, but may not be limited thereto.

In an embodiment of the present disclosure, the graphene filter layer may remove the ink, dye, or the like which is not removed from the drinking water filter of the related art. The ink or dye includes particles in a range of approximately 10 nm to approximately 100 nm, and particles included in the ink or dye may be adsorbed and removed by the oxygen-containing functional group, the pinholes, and the nano-sized pores included in the graphene filter layer, but may not be limited thereto.

In an embodiment of the present disclosure, the graphene filter module may include graphene, graphene oxide, reduced graphene oxide, or graphene nano platelet of approximately 0.1 to approximately 100 parts by weight, but may not be limited thereto.

In an embodiment of the present disclosure, the graphene filter layer of the A-type graphene filter module may include the graphene of approximately 0.1 to 30 parts by weight, but may not be limited thereto. For example, in a case where the graphene of the A-type graphene filter module exceeds 30% by weight, problems such as a decrease in flow rate may occur. Therefore, the graphene is preferably included in an amount of approximately 0.1 to 30 parts by weight.

In an embodiment of the present disclosure, the graphene filter layer of the B-type graphene filter module may include the graphene of approximately 0.1 to approximately 100 parts by weight, but may not be limited thereto.

In an embodiment of the present disclosure, the graphene filter layer may further include at least one material selected from activated carbon, polymer compounds, sand, gravel, and charcoal, but may not be limited thereto.

In an embodiment of the present disclosure, in the case of the A-type graphene filter module, a thickness including all the outer membrane layer, the graphene filter layer, and the inner membrane layer may be approximately 1 to 10 mm, but may not be limited thereto.

In an embodiment of the present disclosure, in the case of the B-type graphene filter module, a thickness of the graphene filter layer may be approximately 0.1 to 100 mm, but may not be limited thereto. For example, in the case of the B-type graphene filter module, the thickness of the graphene filter layer may be approximately 0.1 mm to 100 mm, approximately 0.1 mm to 50 mm, approximately 0.1 mm to 10 mm, approximately 0.1 mm to 1 mm, and approximately 1 mm to 100 mm, approximately 1 mm to 50 mm, approximately 1 mm to 10 mm, approximately 10 mm to 100 mm, approximately 10 mm to 50 mm, or approximately 50 mm to 100 mm, but may not be limited thereto.

In an embodiment of the present disclosure, the graphene filter module can be applied to a device or an article selected from a group consisting of a device or an article, such as a water purifier, a shower, a water bottle, a filter for wastewater treatment, and combinations thereof, but may not be limited thereto.

### Mode of Disclosure

Hereinafter, the present disclosure will be explained in more detail with reference to Examples, but the present disclosure may not be limited thereto.

### EXAMPLES

1. Manufacturing of Graphene Filter Module

1-1. Manufacturing of A-Type Graphene Filter Module

First, other filtering media such as graphene and activated carbon were dispersed in distilled water. Next, a filtering medium to be used as the inner membrane layer was sifted while being floated on the mixed solution in which the graphene is dispersed, so that the material such as the graphene remained in the filtering medium for the inner membrane, or the mixed solution in which the graphene is dispersed passed through the filtering medium to be used as the membrane layer, and thereby the filter material such as the graphene was left.

Thereafter, the filtering medium was dried at a temperature of 80° C. to 150° C. After the drying was completed, the filtering medium to be used as the outer membrane layer was adhered above a layer through which the filter materials such as graphene were filtered, and then dried to a temperature of 30° C. to 60° C.

After the drying, the manufactured triple filter was bent to obtain the A-type filter module.

1-2. Manufacturing of B-Type Graphene Filter Module

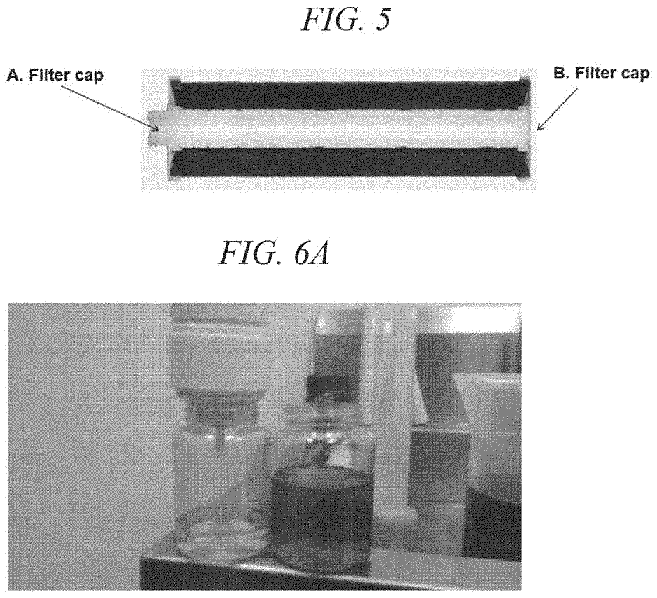

A filtering medium to be used as the outer membrane layer having a thickness of 3 mm to 50 mm made by spun bond or melt blown, and a filtering medium to be used as the inner membrane layer were first combined with a filter cap A having an outflow passage. Thereafter, a portion between the outer membrane layer and the inner membrane layer was filled with the filter material containing the graphene. When the filling was completed, it was sealed with a filter cap B to obtain the B-type graphene filter module (FIG. 5).

2. Confirmation of Water Purification Capacity of Graphene Filter Module

2-1. Wastewater Filtering

Turbidity, COD, ammonia concentration, TDS, and electric conductivity were measured before and after factory wastewater collected from a dyeing factory in China passes through the B-type graphene filter module for 10 minutes to confirm whether the graphene filter module manufactured in the embodiment described above can purify contaminated raw water.

TABLE 1

| Analysis Items | Raw Water | Treated Water |
|---|---|---|
| Turbidity (NTU) | 6.37 | 0 |
| COD (mg/L) | 235 | 20 |
| Hardness (mg/L as CaCO₃) | 294 | 128 |
| Ammonia (mg/L) | 3.1 | 1.9 |
| TDS (mg/L) | 5,600 | 3,990 |
| Electric Conductivity | 12.9 | 10.2 |
| (moves/cm²) | | |

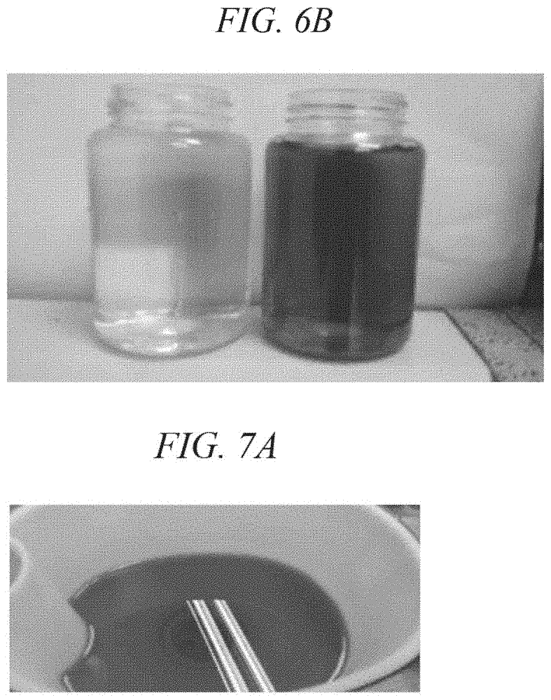

As illustrated in FIG. 6 and Table 1, as a result of allowing the dye wastewater to pass through the graphene filter module, clear purified water was obtained even with the naked eye, and the turbidity, the ammonia concentration, and the like were significantly reduced as a result of the analysis.

2-2. Filtering of Bacterial Contaminated Water

The number of bacteria of Escherichia coli (E. coli) and Staphylococcus aureus (S. aureus) were measured before and after artificially produced bacterial contaminated water passes through the A-type graphene filter module for 10 minutes to confirm that the A-type graphene filter module manufactured in the embodiment described above can purify the contaminated raw water.

TABLE 2

| | | cfu/mL | Efficiency (%) |
|---|---|---|---|
| E. coli | Before | 770,000 | — |
| | After | 6,200 | 99.19 |
| S. aureus | Before | 560,000 | — |
| | After | 5 | 100.00 |

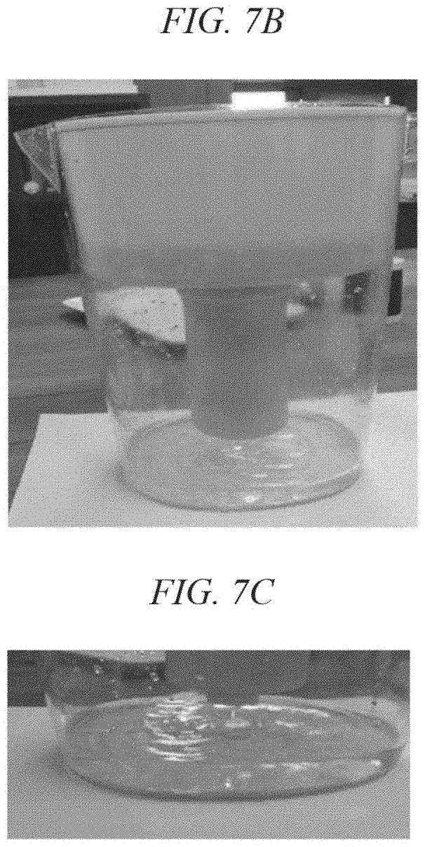

As illustrated in FIG. 7 and Table 2, the A-type graphene filter module can be applied to a kettle-type water purifier, and the E. coli and the S. aureus might be removed by 99% or more.

2-3. Filtering of Bacterial Contaminated Water

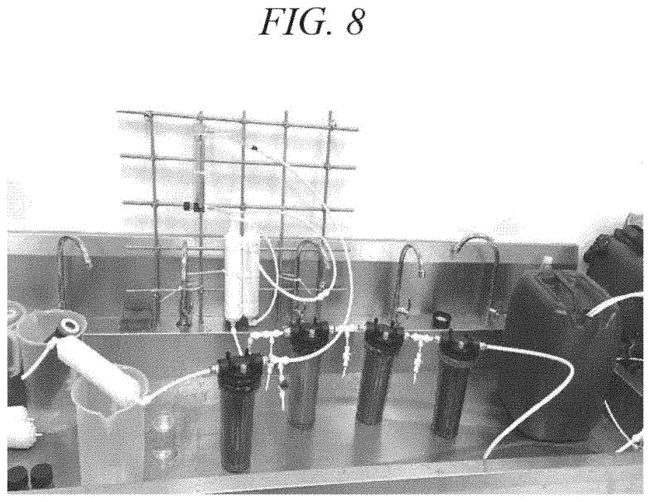

A graphene filter module system was manufactured by extending the B-type graphene filter module manufactured in the example described above to a Lab scale (FIG. 8). The filter system is made of a combination of MF, activated carbon, and a graphene filter, and Table 3 and FIG. 8 illustrate results of treating dye wastewater at a flow rate of 250 mL/min by using the graphene filter system.

TABLE 3

| Contents | Influent | After G-Filtration | |
|---|---|---|---|
| NH₃—N (mg/L) | 1.0 | Not Detected | (100%) |
| Cr⁶⁺ (mg/L) | 0.047 | 0.005 | (89.4%) |
| Mn (mg/L) | 0.535 | 0.009 | (98.3%) |
| Fe (mg/L) | 1.309 | 0.156 | (88.1%) |
| COD (mg/L) | 710 | 80 | (88.7%) |
| Turbidity (NTU) | 138 | 15 | (89.1%) |
| Color (PtCo) | Over Range | Not Detected | (100%) |
| Hardness (mg/L CaCO₃) | 106 | 72 | (32.1%) |

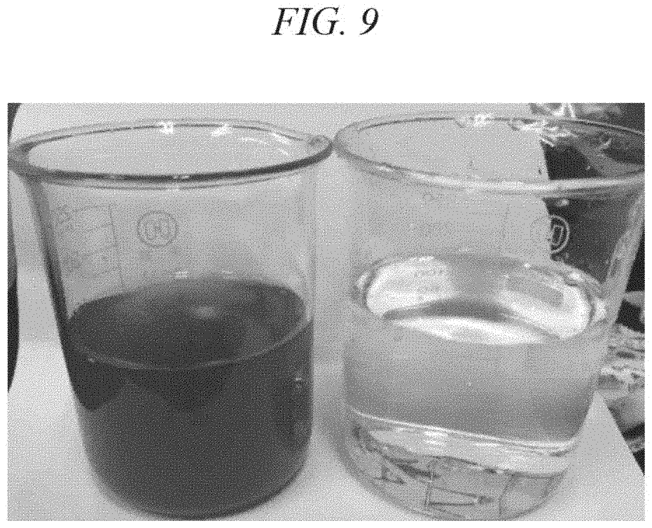

As illustrated in FIG. 9 and Table 3, as a result of allowing the dye wastewater to pass through the filter system including the B-type graphene filter module, heavy metals such as chromium and manganese were effectively removed by approximately 88% or more, a degree of contamination was reduced, and it was confirmed that clear purified water was obtained.

2-4. Comprehensive Filtering Experiment-Taehwa River

Water collected from Taehwa River in Ulsan Metropolitan City of Korea was poured into the A-type graphene filter module manufactured in the example described above and filtered, and then the degree of contamination of the filtered river water was analyzed to be compared.

TABLE 4

| Parameter | Raw | Filtered | Removal (%) |
|---|---|---|---|
| Total colonies General | 385 | 0 | 100 |
| Bacteria (cfu/mL) | | | |
| Fluoride (mg/L) | 0.75 | N/D | 100 |
| Chloroform (mg/L) | 0.55 | N/D | 100 |
| Total Trihalomethane (mg/L) | 0.015 | N/D | 100 |
| Bromodichloromethane | 0.005 | N/D | 100 |
| (mg/L) | | | |
| Dibromochloromethane (mg/L) | 0.005 | N/D | 100 |
| Manganese (mg/L) | 0.035 | N/D | 100 |
| Turbidity (NTU) | 1.05 | 0.09 | 91 |
| boron (mg/L) | 1.15 | 0.31 | 73 |
| Permanganate consumption | 58.5 | 24.9 | 57 |
| value (mg/L) | | | |
| Total hardness (mg/L) | 6,080 | 3,105 | 49 |
| Aluminum (mg/L) | 0.25 | 0.19 | 24 |

As illustrated in Table 4, the collected raw water contains bacteria, includes heavy metals and the like, and has a high turbidity, but as a result of passing through the graphene filter module, it might be confirmed that heavy metals, bacteria, and the like were effectively removed.

2-5. Comprehensive Filtering Experiment

Artificially manufactured polluted water was poured into a prototype of a gravity type water purifier including the A-type graphene filter module manufactured in the example described above and filtered, and then the degree of contamination of the filtered raw water was commissioned to a water purifier test institution, and analyzed according to Korean evaluation standards.

As a result of the filtering, contaminants such as bacteria and heavy metals, as well as ultra-fine particles that are not removed by a general filter, were removed, and thus it was confirmed that the water met the standard of Korean drinking water.

TABLE 5

| | | | In Flow | Out Flow | Removal |
|---|---|---|---|---|---|
| No. | Item | Unit | Concentration | Concentration | Rate (%) |
| 1 | E. Coli | CFU/L | 720 | Not detected | 100 |
| 2 | Available Free | mg/L | 2.01 | Not detected | 100 |
| | Residual chlorine | | | | |
| 3 | Chloroform | mg/L | 0.30 | Not detected | 100 |
| 4 | 1,1-Dichloroethylene | mg/L | 0.27 | Not detected | 100 |
| 5 | Carbon tetrachloride | mg/L | 0.02 | Not detected | 100 |
| 6 | 1,2-Dibromo-3- | mg/L | 0.01 | Not detected | 100 |
| | chloropropane | | | | |
| 7 | Chloral hydrate | mg/L | 0.09 | Not detected | 100 |
| 8 | Dibromoacectonitrile | mg/L | 0.32 | Not detected | 100 |
| 9 | Dichloroacetonitrile | mg/L | 0.29 | Not detected | 100 |
| 10 | Trichloroacetonitrile | mg/L | 0.04 | Not detected | 100 |
| 11 | Haloacetic acid | mg/L | 0.28 | Not detected | 100 |
| 12 | 1,4-dioxane | mg/L | 0.15 | Not detected | 100 |
| 13 | Trihalomethanes | mg/L | 0.337 | Not detected | 100 |
| 14 | 1,1,1-Trichloroethane | mg/L | 0.305 | Not detected | 100 |
| 15 | Trichloroethylene | mg/L | 0.295 | Not detected | 100 |
| 16 | Tetrachloroethylene | mg/L | 0.096 | Not detected | 100 |
| 17 | Dichloromethane | mg/L | 0.208 | Not detected | 100 |
| 18 | Benzene | mg/L | 0.101 | Not detected | 100 |
| 19 | Toluene | mg/L | 2.069 | Not detected | 100 |
| 20 | Ethylbenzene | mg/L | 0.907 | Not detected | 100 |
| 21 | Xylenes | mg/L | 1.733 | Not detected | 100 |
| 22 | Diazinon | mg/L | 0.0637 | Not detected | 100 |
| 23 | Parathion | mg/L | 0.1998 | Not detected | 100 |
| 24 | Fenitrothion | mg/L | 0.135 | Not detected | 100 |
| 25 | Carbaryl | mg/L | 0.198 | Not detected | 100 |
| 26 | Phenols | mg/L | 0.049 | Not detected | 100 |
| 27 | Alkyl Benzene | mg/L | 1.600 | Not detected | 100 |
| | Sulfonate | | | | |
| 28 | Mercury (Hg) | mg/L | 0.011 | Not detected | 100 |
| 29 | Lead (Pb) | mg/L | 0.505 | Not detected | 100 |
| 30 | Iron (Fe) | mg/L | 0.88 | Not detected | 100 |
| 31 | Turbidity | NTU | 5.11 | 0.04 | 99 |
| 32 | Copper (Cu) | mg/L | 3.21 | 0.035 | 99 |
| 33 | Aluminum (Al) | mg/L | 0.63 | 0.03 | 95 |
| 34 | color | Degree | 15 | 1.00 | 93 |
| 35 | Chrome (Cr) | mg/L | 0.510 | 0.35 | 31 |
| 36 | Cadmium (Cd) | mg/L | 0.047 | 0.033 | 30 |

2-6. Comprehensive Filtering Experiment

Table 6 illustrates field test results analyzed by Parogon Lab for 48 parameters of tap water collected from Flint, Mich., USA by using the A-type filter module. Table 6 illustrates results of measuring heavy metals in raw water, results of filtering general tap water, and analysis results after passing through the graphene filter module according to the embodiment described above of the present application. Chlorine ions and the like were not removed in the results of filtering the general tap water, but in a case of using the graphene filter module of the present application, contaminants such as bacteria and heavy metals, as well as ultra-fine particles, which were not removed by a general filter, were removed, and it was confirmed that the water met the US and WHO criteria.

TABLE 6

| | | | | | | Analysis Results | | |
|---|---|---|---|---|---|---|---|---|
| | | Detecting | Detecting Water Limit | | | | After Faucet | After SG |
| Parameter | Unit | Limit | US EPA MCL* | | WHO | Tap Water | Filter | Filter |
| Hardness, Total as CaCO₃ | mg/L | 1.0 | NA** | | NA | 120 | 110 | 100 |
| Dichloroacetic acid (DCAA) | μg/L | 1.0 | NA | (MCLG*** = 0) | 50 | 7.5 | 8.6 | Not |
| | | | | | | | | Detectable |
| Trichloroacetic acid (TCAA) | μg/L | 1.0 | NA | (MCLG = 20) | 200 | 7.9 | 8.3 | Not |
| | | | | | | | | Detectable |
| Haloacetic Acids, Total (HAA5) | μg/L | 1.0 | 60 | | NA | 15 | 17 | Not |
| | | | | | | | | Detectable |
| Chloride | mg/L | 5.0 | 250 | | NA | 10 | 10 | 10 |
| Fluoride | mg/L | 0.10 | 4 | | 1.5 | 0.65 | 0.65 | 0.64 |
| Nitrate Nitrogen, as N (NO₃—N) | mg/L | 0.050 | 10 | | 50 | 0.3 | 0.3 | 0.56 |
| Sulfate | mg/L | 5.0 | 250 | | NA | 21 | 21 | 20 |
| Chromium, Total | mg/L | 0.0010 | 0.1 | | 0.05 | 0.0013 | 0.0011 | Not |
| | | | | | | | | Detectable |
| Copper, Total | mg/L | 0.0010 | 1.3 | | 2 | 0.008 | 0.016 | Not |
| | | | | | | | | Detectable |
| Lead, Total | mg/L | 0.0010 | 0.015 | | 0.01 | Not | Not | Not |
| | | | | | | Detectable | Detectable | Detectable |
| Sodium | mg/L | 0.50 | NA | | NA | 7.7 | 7.7 | 7.8 |
| E. coli | | 1 | Absence | | NA | Absence | Absence | Absence |
| Aerobic Plate Count | CFU/mL | 1 | 500 | | NA | 8 | Not | Not |
| | | | | | | | Detectable | Detectable |
| Bromodichloromethane | μg/L | 0.50 | NA | (MCLG = 0) | 60 | 6.8 | 6.5 | Not |
| | | | | | | | | Detectable |
| Chloroform | μg/L | 0.50 | NA | (MCLG = 70) | 300 | 15 | 15 | Not |
| | | | | | | | | Detectable |
| Dibromochloromethane | μg/L | 0.50 | NA | (MCLG = 60) | 70 | 2.5 | 2.5 | Not |
| | | | | | | | | Detectable |

| | | | | | | | |
|---|---|---|---|---|---|---|---|
| Trihalomethanes, Total (TTHM) | μg/L | 0.50 | 80 | 1000 | 25 | 24 | Not |
| | | | | | | | Detectable |

MCL*: Minimum Contaminant Level, The highest level of a contaminant that is allowed in drinking water. MCLs are set as close to MCLGs as feasible using the best available treatment technology and taking cost into consideration. MCLs are enforceable standards.
NA**: Not Available
MCLG***: Maximum Contaminant Level Goal, The level of a contaminant in drinking water below which there is no known or expected risk to health. MCLGs allow for a margin of safety and are non-enforceable public health goals.

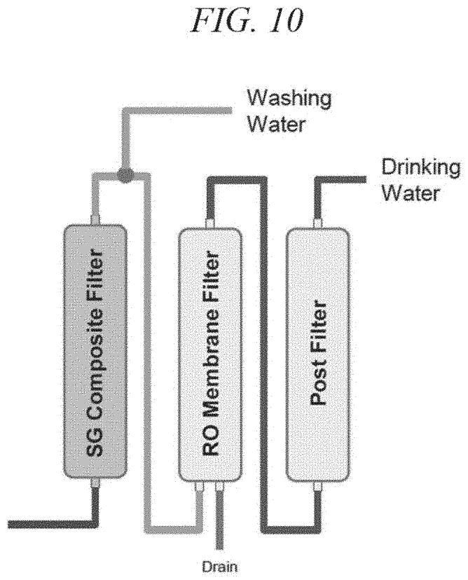

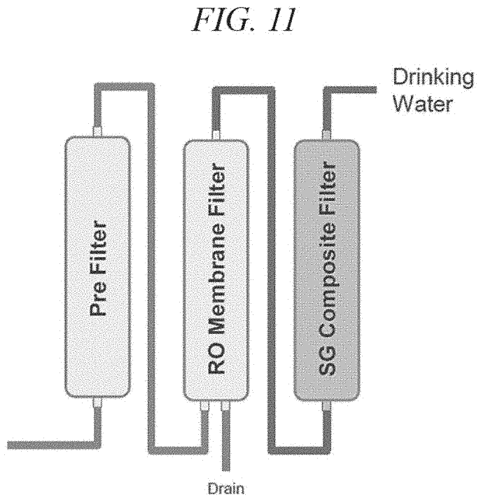

FIGS. 10 and 11 illustrate examples applied to a reverse osmosis (RO) water purifier using the graphene filter module manufactured in the example described above.

FIG. 10 is an example of installing the graphene filter module (SG composite filter) according to the present example in front of a reverse osmosis membrane filter (RO membrane filter). In this case, it can remove fine dust, residual chlorine, microorganisms, and the like that cause contamination and scale generation of the reverse osmosis membrane filter. Thereby, it has an advantage of increasing the life of the reverse osmosis membrane filter, improving a recovery ratio, or providing safer washing water from which microorganisms such as bacteria are removed.

FIG. 11 is an example in which the graphene filter module (SG composite filter) according to the present example is installed behind the RO membrane filter. In this case, drinkable water in which microorganisms such as bacteria are removed can be supplied.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A graphene filter module comprising:
an outer membrane layer forming an outer surface of the graphene filter module;
an inner membrane layer disposed inside the outer membrane layer; and
a graphene filter layer disposed between the outer membrane layer and the inner membrane layer,
wherein inflow water is filtered through the outer membrane layer, the graphene filter layer, and the inner membrane layer.

2. The graphene filter module of claim 1,
wherein the graphene filter module is formed in a corrugated membrane structure consisting of the outer membrane layer, the graphene filter layer, and the inner membrane layer; or is formed in a structure including a graphene filter layer which is filled with graphene in a powder form.

3. The graphene filter module of claim 1,
wherein the graphene filter layer includes at least one selected from graphene, graphene oxide, reduced graphene oxide, and graphene nano platelet.

4. The graphene filter module of claim 1,
wherein the graphene filter layer further includes at least one material selected form activated carbon, carbon black, zeolite, silica, ion exchange resin, alumina, KDF filter, ceramic ball, and carbon nanotube.

5. The graphene filter module of claim 1,
wherein the graphene filter layer includes graphene, graphene oxide, reduced graphene oxide, or graphene nano platelet of 0.1 to 100 parts by weight.

6. The graphene filter module of claim 1,
wherein a pore size of the graphene filter layer is 1 nm to 20 nm.

7. The graphene filter module of claim 1,
wherein fine particles having a diameter of less than 10 μm included in the inflow water are removed by the graphene filter layer.

8. The graphene filter module of claim 1,
wherein each of the outer membrane layer and the inner membrane layer is independently formed of at least one different material selected from cellulose, glass fiber, polyethylene, polypropylene, carbon fiber, activated carbon, and polyethylene terephthalate.

9. The graphene filter module of claim 1,
wherein a pore size of the outer membrane layer is 0.1 μm to 100 μm.

10. The graphene filter module of claim 1,
wherein a pore size of the inner membrane layer is 0.1 μm to 10 μm.
